(19) United States
(12) Patent Application Publication
(10) Pub. No.: US 2025/0307392 A1
(43) Pub. Date: Oct. 2, 2025

(54) INFORMATION PROCESSING DEVICE, INFORMATION PROCESSING METHOD, AND NON-TRANSITORY COMPUTER READABLE MEDIUM

(71) Applicant: Mitsubishi Electric Corporation, Tokyo (JP)

(72) Inventors: Aiko IWASAKI, Tokyo (JP); Takumi YAMAMOTO, Tokyo (JP)

(73) Assignee: Mitsubishi Electric Corporation, Tokyo (JP)

(21) Appl. No.: 19/240,749

(22) Filed: Jun. 17, 2025

Related U.S. Application Data
(63) Continuation of application No. PCT/JP2023/005643, filed on Feb. 17, 2023.

(51) Int. Cl. G06F 21/55

(52) U.S. Cl. CPC G06F 21/554; G06F 2221/034

(57) ABSTRACT

An information processing device (100) includes a decoy theme estimation unit (130) that estimates a decoy theme which is a theme of information that a high risk user being a user of a target system is attempting to leak externally, based on an access log (21) indicating access in the target system by the high risk user, and a decoy placement unit (140) that places a decoy file matching the estimated decoy theme in the target system.

### CROSS REFERENCE TO RELATED APPLICATION

This application is a Continuation of PCT International Application No. PCT/JP2023/005643, filed on Feb. 17, 2023, which is hereby expressly incorporated by reference into the present application.

### TECHNICAL FIELD

This disclosure relates to an information processing device, information processing method, and information processing program.

### BACKGROUND ART

Patent Literature 1 discloses a technique for generating decoy data (specifically, decoy mail) that includes information (for example, information including a URL (Uniform Resource Locator), ID (Identification), and password) to entice a third party intercepting mail on the network to access a decoy server, and placing the generated decoy data on the network. Here, arbitrary decoy files are placed on the decoy server. Additionally, it is preferable for the decoy file to include performance information, new product information, confidential information, new technology information, personal information, and the like.

### CITATION LIST

### Patent Literature

Patent Literature 1: JP 2010-134832 A

### SUMMARY OF INVENTION

### Technical Problem

When the attacker is a malicious third party, it is sufficient to prepare decoy data related to information the attacker is interested in and specific information generally known to be attractive to the attacker, and place the prepared decoy data on the network as in the prior art. The specific information includes, for example, information indicating at least one of an ID, password, system configuration, personal information, and finance.

However, considering information leakage by internal fraudsters, information contained in various files created in daily operations may also become targets for theft. An internal fraudster is, for example, a malicious employee. Here, if decoy data is prepared for all files, the amount of decoy data becomes enormous. Moreover, since it is assumed that internal fraudsters have the intention to leak information that matches some theme, it is not effective to present to the internal fraudsters decoy files that do not match the internal fraudster's theme. The theme is, for example, “defense-related,” “machine learning-related,” or “design document-related”. Furthermore, if a large amount of decoy files that do not match the internal fraudster's theme are presented, or if the contents of the decoy files are not pertinent to the company's business, there is a higher possibility that the internal fraudster will realize that the presented files are decoy files, so it is necessary to devise the contents of the decoy files.

The present disclosure aims to automatically place a decoy file that matches a theme estimated to be the theme of the information that the internal fraudster is attempting to leak externally, in a deception system using decoy data.

### Solution to Problem

An information processing device according to the present disclosure includes:
a decoy theme estimation unit to estimate a decoy theme which is a theme of information that a high risk user being a user of a target system is attempting to leak externally, based on an access log indicating access in the target system by the high risk user; and
a decoy placement unit to place a decoy file matching the estimated decoy theme in the target system.

### Advantageous Effects of Invention

According to the present disclosure, a decoy theme estimation unit estimates, based on an access log, a theme of information that a high risk user is attempting to leak externally, and a decoy placement unit places in a target system a decoy file that matches the estimated theme. Here, the high risk user may also be an internal fraudster. Therefore, according to the present disclosure, in a deception system using decoy data, it is possible to automatically place a decoy file that matches the theme estimated to be the theme of the information that the internal fraudster is attempting to leak externally.

### BRIEF DESCRIPTION OF DRAWINGS

FIG. 1 is a diagram that describes file access of an internal fraudster.

FIG. 2 is a diagram showing a configuration example of an information processing device 100 according to Embodiment 1.

FIG. 3 is a diagram showing a configuration example of the information processing system 90 according to Embodiment 1.

FIG. 4 is a diagram showing a hardware configuration example of the information processing device 100 according to Embodiment 1.

FIG. 5 is a flowchart showing operation of the information processing device 100 according to Embodiment 1.

FIG. 6 is a flowchart showing operation of a decoy theme estimation unit 130 according to Embodiment 1.

FIG. 7 is a flowchart showing operation of the decoy theme estimation unit 130 according to Embodiment 1.

FIG. 8 is a flowchart showing operation of a decoy placement unit 140 according to Embodiment 1.

FIG. 9 is a flowchart showing operation of the decoy placement unit 140 according to Embodiment 1.

FIG. 10 is a diagram showing a hardware configuration example of the information processing device 100 according to a modification of Embodiment 1.

FIG. 11 is a diagram showing a configuration example of an information processing device 100 according to Embodiment 2.

FIG. 12 is a flowchart showing operation of the information processing device 100 according to Embodiment 2.

FIG. 13 is a diagram showing a configuration example of an information processing device 100 according to Embodiment 3.

FIG. 14 is a diagram showing a configuration example of an information processing device 100 according to Embodiment 4.

### DESCRIPTION OF EMBODIMENTS

In the description and drawings of the embodiments, the same reference numerals are assigned to the same elements and equivalent elements. The description of elements with the same reference numerals is omitted or simplified as appropriate. The arrows in the drawings mainly indicate the flows of data or the flows of processing. Also, the word “unit” may be appropriately replaced with “circuit”, “stage”, “procedure”, “process”, or “circuitry”.

### Embodiment 1

Below, this Embodiment will be described in detail with reference to the drawings.

Even for an internal fraudster, it is difficult to target and view only the files containing the information they are seeking, so it is considered that they will search for files containing the information they are seeking while checking various files. An internal fraudster is an entity that operates within an organization with the aim of stealing data from the organization. An internal fraudster is, for example, an internal culprit in a target system 20, or malware that has stolen legitimate credentials and is infecting a PC (Personal Computer) used in the organization managing the target system 20. An internal culprit is a user with legitimate access permission who is involved in a security attack within the organization. An internal culprit is also a user with malicious intent. Malware, for example, operates autonomously on its own or operates according to instructions from an external attacker via a Command & Control server on the Internet.

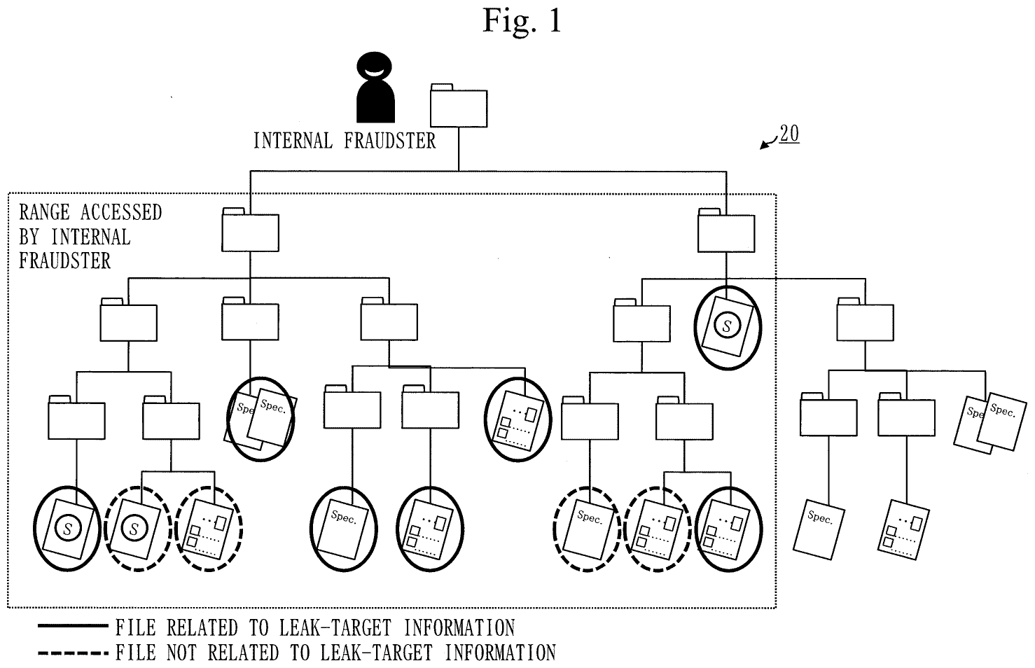

FIG. 1 is a diagram describing file access of an internal fraudster. In FIG. 1, the circle-enclosed S indicates confidentiality. As shown in FIG. 1, when an internal fraudster searches for a file containing the information they are seeking, they basically access both files related to the information they want to leak and files not related to the information they want to leak. Therefore, it is desirable to predict the information that a certain employee is seeking based on several files viewed before being judged as an internal fraudster, and prepare a decoy file based on the predicted information.

Here, it is not realistic to pre-label themes for all files created in daily operations. The themes, for example, include “defense-related,” “machine learning-related,” or “design document-related” themes. Also, pre-labeling files every time they are newly created or modified may hinder normal operations.

Therefore, in this Embodiment, an employee considered to be an internal fraudster is identified, the themes of the files viewed by the identified employee are checked, the theme of interest to the identified employee is estimated based on the checked themes, a decoy file matching the estimated theme is prepared, and the prepared decoy file is placed.

### ***Description of Configuration***

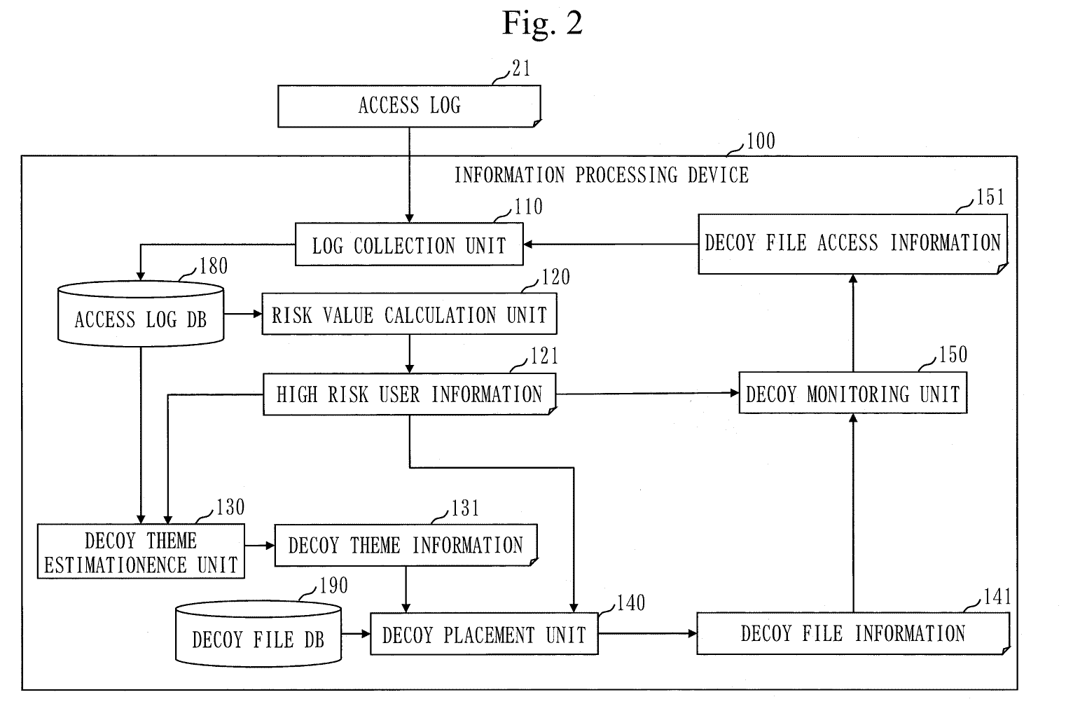

FIG. 2 shows an example configuration of an information processing device 100 according to this Embodiment. The information processing device 100, as shown in FIG. 2, includes a log collection unit 110, a risk value calculation unit 120, a decoy theme estimation unit 130, a decoy placement unit 140, and a decoy monitoring unit 150. Additionally, the information processing device 100 stores an access log DB (Database) 180 and a decoy file DB 190.

The log collection unit 110 collects an access log 21 and an access log for a decoy file 191, and records the collected logs in the access log DB 180. The access log 21 is a log of file access in the target system 20.

The decoy file 191 is a file used to detect internal fraudsters and is, for example, a presentation material or a data set for image processing. The decoy file 191 is a file generated to match an individual theme that can be outputted as a decoy theme by the decoy theme estimation unit 130. The decoy file 191 may be a file generated manually, a file generated by modifying an authorized file, a file generated according to a predetermined rule, a file generated using natural language processing, or a file generated using AI (Artificial Intelligence) technology.

The decoy file 191 is basically a file generated so as not to arouse suspicion from internal fraudsters. For example, the file name of the decoy file 191 follows a predetermined naming convention, the icon of the decoy file 191 is the same as that of an authorized file, and the content of the decoy file 191 superficially resembles the content of an authorized file.

The target system 20 is a computer system used by multiple users in business operations and stores multiple files. The target system 20 is, for example, a system operated based on zero trust and consists of at least one or the other of an on-premises system and a cloud system. The target system 20 manages each file of the multiple files as part of a file tree. A file tree is a file system that hierarchically manages multiple files. In the target system 20, each file is stored in a folder, and each user accesses each file managed by the target system 20 using a file access tool. A folder is also called a directory. A file access tool is a tool for each user to access each file and is, for example, an explorer or a browser. Each user is a user of the target system 20. Each user may be a human or a computer.

The risk value calculation unit 120 calculates a risk value corresponding to each user based on logs such as file access in the target system 20. When the decoy file 191 is not placed, the risk value calculation unit 120 typically calculates the risk value corresponding to each user based on the access pattern in the target system 20 of each user of the target system 20. Even when the decoy file 191 is placed, the risk value calculation unit 120 may also calculate the risk value corresponding to each user based on the access pattern of each user in the target system 20. When the decoy file 191 is placed in the target system 20, the risk value calculation unit 120 may use an access log for the decoy file 191 when calculating the risk value corresponding to each user. The risk value calculation unit 120 may increase the risk value corresponding to the target user if the target user accesses at least one of the one or more decoy files 191.

The risk value corresponding to each user is a value calculated according to the behavior of each user in the target system 20. The risk value is also a value corresponding to the possibility that each user is actually an internal fraudster. The behavior of each user in the target system 20 is the actions of each user in the target system 20. The components of each user's behavior include, as a specific example, files accessed by each user, the order of file access by each user, the time period during which each user executed file access, and the number of files accessed per unit time by each user.

The risk value calculation unit 120 may model the pattern of normal behavior in the target system 20 for each user in advance from logs such as file access, and calculate the degree of deviation of the actual behavior of each user in the target system 20 from the modeled pattern of normal behavior, as the risk value corresponding to each user. The risk value calculation unit 120 may utilize technologies such as machine learning when modeling the pattern of normal behavior, and may use technologies such as User and Entity Behavior Analytics (UEBA) to detect anomalies in behavior for each user based on access logs.

Additionally, the risk value calculation unit 120 generates high risk user information 121 and outputs the generated high risk user information 121. The high risk user information 121 is information indicating each high risk user and the characteristics of each high risk user. The high risk user information 121 includes, as specific examples, data indicating each high risk user, the risk value corresponding to each high risk user, and one or more files accessed by each high risk user. A high risk user is a user of the target system 20 and is, among the users of the target system 20, a user whose corresponding risk value is equal to or greater than a risk criterion value being a predetermined threshold, who has a relatively high possibility of being an internal fraudster. Note that when at least one or the other of the access log 21 and the decoy file access information 151 is updated, the high risk user information 121 may also be updated based on the updated information.

The decoy theme estimation unit 130 estimates the decoy theme based on the access log indicating access in the target system 20 by a high risk user, generates decoy theme information 131 indicating the estimated decoy theme, and outputs the generated decoy theme information 131. The decoy theme estimation unit 130 may estimate the decoy theme using at least one or the other of natural language processing and a theme list consisting of multiple themes each of which is a candidate for the decoy theme. The theme list is a list consisting of multiple themes each of which is a candidate for the decoy theme. Each theme may be a word. Themes included in the theme list are, as specific examples, words such as “traffic”, “defense”, and “communication”.

A decoy theme is a theme estimated to be of interest to the high risk user, which is the theme of information that the high risk user is attempting to leak externally. A decoy theme may be a business level theme such as “traffic”, “defense”, and “communication”, a technique level theme such as “AI”, “image processing”, and “behavior detection”, a document level theme such as “system design document” and “proposal”, a format level theme such as “text document” and “presentation material”, or a combination of these.

Additionally, a decoy theme does not necessarily have to be a linguistically expressed theme as described above. As a specific example, a file selected based on the high similarity between documents analyzed using the natural language processing may be used as a decoy theme. In a detailed example, the decoy theme estimation unit 130 classifies files accessed by a high risk user using a clustering technique and estimates a cluster consisting of the most files among the generated clusters, as the cluster of the decoy theme. Subsequently, a decoy file 191 most similar to the cluster corresponding to the decoy theme estimated by the decoy theme estimation unit 130 is selected from the decoy file DB 190.

As a specific example, the decoy theme estimation unit 130 estimates a decoy theme by analyzing themes based on the folder name of the folder viewed by the high risk user and the file name and content of the file viewed by the high risk user. Note that the decoy theme estimation unit 130 may estimate multiple decoy themes as decoy themes corresponding to a certain high risk user. Also, since the high risk user does not necessarily access only files related to the information they want to leak, a theme unrelated to the theme in which the high risk user is actually interested may be estimated as the decoy theme.

The decoy placement unit 140 selects one or more decoy files 191 from the decoy file DB 190 based on the decoy theme estimated by the decoy theme estimation unit 130 and places the selected one or more decoy files 191 in a placement target area. Placing the decoy file 191 includes instructing a plug-in or the like to place the decoy file 191. The placement target area is an area corresponding to part of the file tree managed by the target system 20. The placement target area may be an area including a folder where files matching the decoy theme estimated by the decoy theme estimation unit 130 are placed, an area including a vicinity of the area accessed by the high risk user, or an area including an area expected to be accessed by the high risk user in the future. The decoy placement unit 140 may select the decoy file 191 from the decoy file DB 190 using at least one or the other of the natural language processing and the theme list

Specifically, the decoy placement unit 140 selects one or more decoy files 191 matching the decoy theme estimated by the decoy theme estimation unit 130 from the decoy file DB 190, executes an instruction for the target system 20 to place each selected decoy file 191 in the placement target area, generates decoy file information 141 corresponding to the executed instruction, and outputs the generated decoy file information 141. Decoy file information 141 corresponding to a certain decoy file 191 is information indicating the file name, placement location, and so on of the certain decoy file 191. The decoy placement unit 140 may place the decoy file 191 in the target system 20 instead of executing the instruction for the target system 20 to place the decoy file 191.

Note that the decoy placement unit 140 may extract topics from the content, file name, and so on of files accessed by the high risk user, further narrow down the area where files or directories related to the extracted topics exist, and place the decoy file 191 in the narrowed-down area. In this case, the decoy placement unit 140 may use a topic model such as Top2Vec to extract the topics.

The decoy placement unit 140 may create a decoy folder and execute an instruction for the target system 20 to place the decoy file 191 in the created decoy folder. The decoy placement unit 140 may add information indicating that access to the decoy file 191 is made, to the access log 21 corresponding to each user.

The decoy monitoring unit 150 monitors access to each decoy file 191 indicated by the decoy file information 141 in relation to each high risk user indicated by the high risk user information 121, generates decoy file access information 151 corresponding to the monitored results, and outputs the generated decoy file access information 151. For example, the decoy file access information 151 is information indicating that, when there is a high risk user who has accessed the decoy file 191 a predetermined number of times or more, the high risk user has accessed the decoy file 191 a predetermined number of times or more. The decoy file access information 151 may be information indicating that a user other than the high risk user has accessed the decoy file 191. A method of selecting the decoy file 191 based on the estimated decoy theme is, as a specific example, a method using a rule base, or a method using natural language processing technology.

An analyst may narrow down high risk users based on the decoy file access information 151 and the high risk user information 121, and may reflect the narrowed-down results in the high risk user information 121. An analyst is, as a specific example, a person or computer analyzing security attacks in the target system 20.

The access log DB 180 is a database that stores information indicating access logs in the target system 20.

The decoy file DB 190 is a database that stores one or more decoy files 191, and stores files that are candidates for the decoy file 191. In the decoy file DB 190, decoy files 191 corresponding to each decoy theme that the decoy theme estimation unit 130 can output are stored.

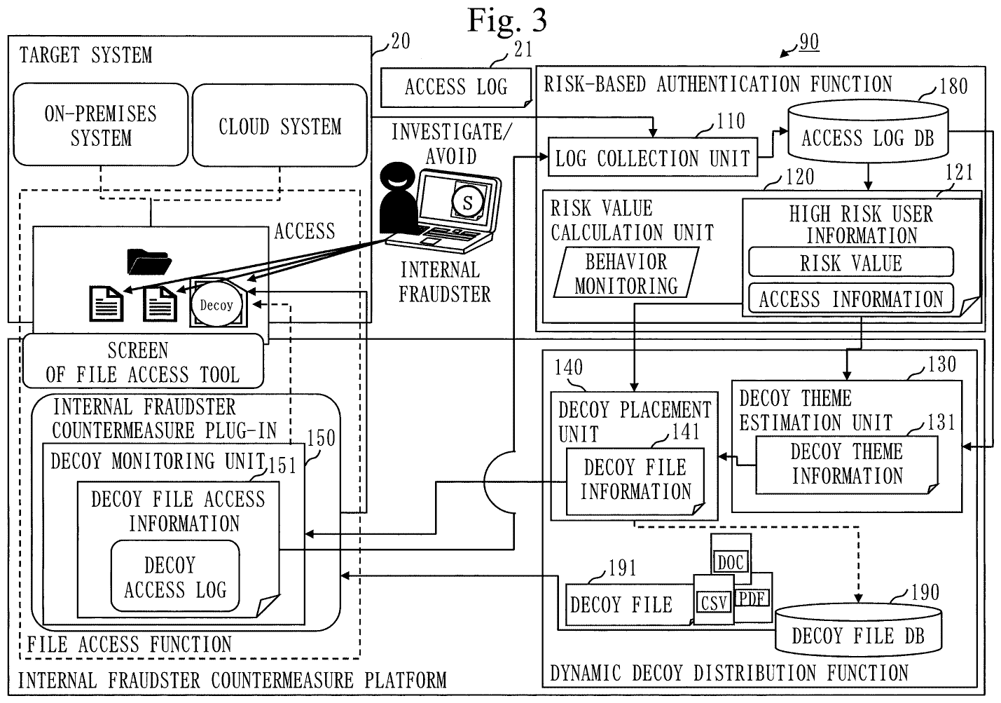

FIG. 3 shows an example of an information processing system 90 according to this Embodiment. Using FIG. 3, an example of the information processing system 90 is described. In FIG. 3, the information processing device 100 is illustrated as being divided according to the functions. Here, an internal fraudster is assumed to investigate files within the target system 20.

The risk-based authentication function, by utilizing the risk-based authentication technique, receives the access log 21 of each user from the target system 20 and calculates the risk value corresponding to each user based on the received log. Also, if the decoy file 191 is already placed, the risk value calculation unit 120 refers to the access log for the decoy file 191 when calculating the risk value for each user.

An internal fraudster countermeasure platform is a system with internal fraudster countermeasure functions and includes a dynamic decoy distribution function and a file access function.

The dynamic decoy distribution function selects a folder to place the decoy file 191, selects the decoy file 191, and places the selected decoy file 191 in the selected folder.

The decoy placement unit 140 instructs an internal fraudster countermeasure plug-in to place the decoy file 191.

The internal fraudster countermeasure plug-in is a software module that implements additional functions for the file access tool. The functions of the decoy monitoring unit 150 are implemented by the internal fraudster countermeasure plug-in.

The file access tool that implements the file access function uses the internal fraudster countermeasure plug-in to place the decoy file 191 based on the instructions of the dynamic decoy distribution function. The internal fraudster countermeasure plug-in may actually place the decoy file 191 in the target system 20, or may display the decoy file 191 on an operation screen of the file access tool when each user accesses a folder where the decoy file 191 should be placed, instead of actually placing the decoy file 191 in the target system 20.

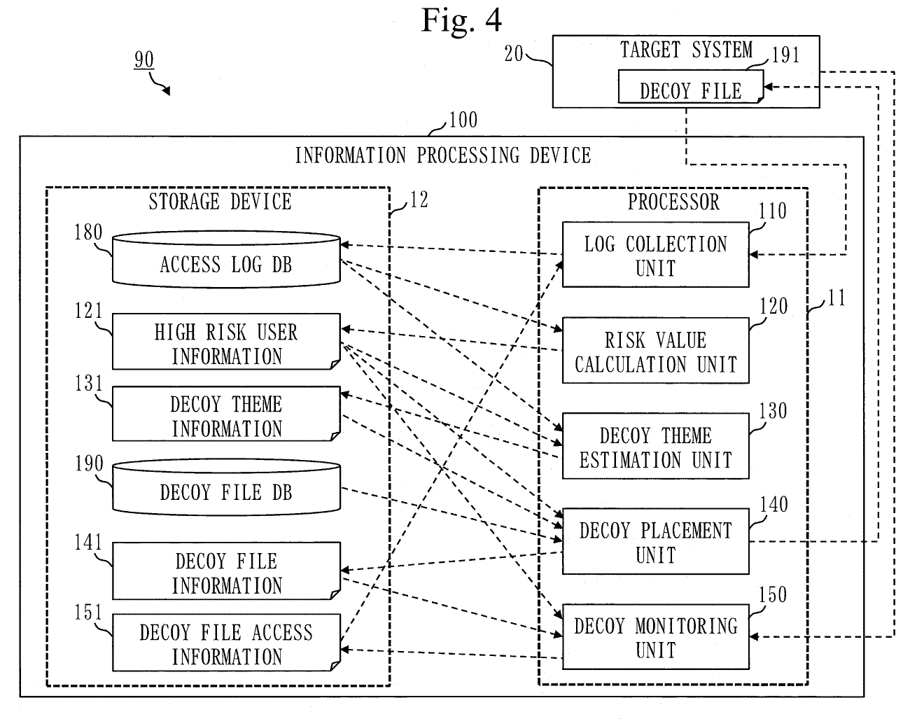

FIG. 4 shows a hardware configuration example of the information processing device 100 according to this Embodiment. The information processing device 100 is constituted of a general-purpose computer. The information processing device 100 may be constituted of multiple computers. The target system 20 and the information processing device 100 may be integrally configured.

The information processing device 100 is, as shown in this figure, a computer equipped with hardware such as a processor 11 and a storage device 12. These hardware components are appropriately connected via a signal line.

The processor 11 is an IC (Integrated Circuit) that performs arithmetic processing and controls the hardware provided to the computer. The processor 11 is, as a specific example, a CPU (Central Processing Unit), a DSP (Digital Signal Processor), or a GPU (Graphics Processing Unit).

The information processing device 100 may be equipped with multiple processors that substitute for the processor 11. The multiple processors share the role of the processor 11.

The storage device 12 consists of at least one or the other of a volatile storage device and a non-volatile storage device. The volatile storage device is, for example, a RAM (Random Access Memory). The non-volatile storage device is, for example, a ROM (Read Only Memory), an HDD (Hard Disk Drive), or a flash memory. Data stored in the storage device 12 is loaded into the processor 11 as needed.

The information processing device 100 may be equipped with hardware such as an input/output IF (Interface) and a communication device.

The input/output IF is a port to which input and output devices are connected. The input/output IF is, for example, a USB (Universal Serial Bus) terminal. The input device is constituted of, for example, a keyboard and a mouse. The output device is, for example, a display.

The communication device is a receiver/transmitter. The communication device is, for example, a communication chip or an NIC (Network Interface Card).

Each part of the information processing device 100 may appropriately use the input/output IF and the communication device when communicating with other devices or the like.

The storage device 12 stores an information processing program. The information processing program is a program that enables the computer to implement the function of each part of the information processing device 100. The information processing program is loaded into the storage device 12 and executed by the processor 11. The function of each part of the information processing device 100 is implemented by software.

The storage device 12 may store files managed by the target system 20.

Data used when executing the information processing program, data obtained by executing the information processing program, and the like are appropriately stored in the storage device 12. Each part of the information processing device 100 appropriately utilizes the storage device 12. It should be noted that the term “data” and the term “information” may sometimes have equivalent meanings.

The storage device 12 may be independent of the computer. Each database may be stored on an external server or the like.

The information processing program may be recorded on a computer readable non-volatile recording medium. The non-volatile recording medium is, for example, an optical disc or flash memory. The information processing program may be provided as a program product.

### ***Description of Operation***

An operation procedure of the information processing device 100 corresponds to an information processing method. Also, a program that implements the operation of information processing device 100 corresponds to the information processing program.

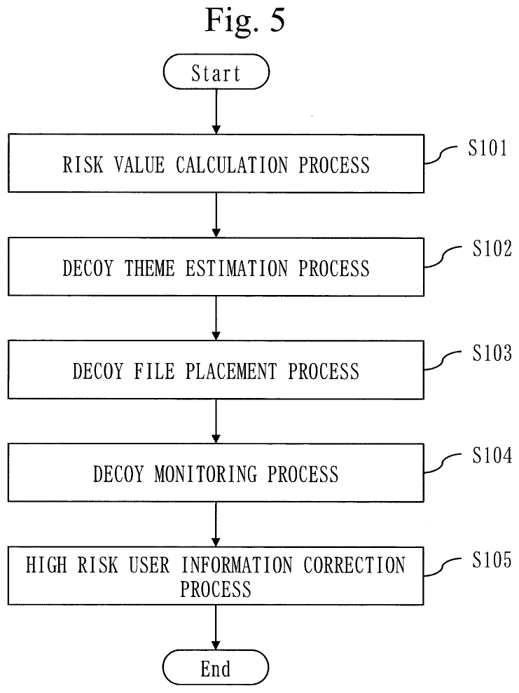

FIG. 5 is a flowchart showing an example of operation of the information processing device 100. FIG. 5 is used to describe the operation of the information processing device 100.

### (Step S101: Risk Value Calculation Process)

The risk value calculation unit 120 refers to the access log DB 180 and calculates a risk value related to the behavior of each user based on the log of file access.

### (Step S102: Decoy Theme Estimation Process)

The decoy theme estimation unit 130 estimates the decoy theme based on the log of file access by high risk users.

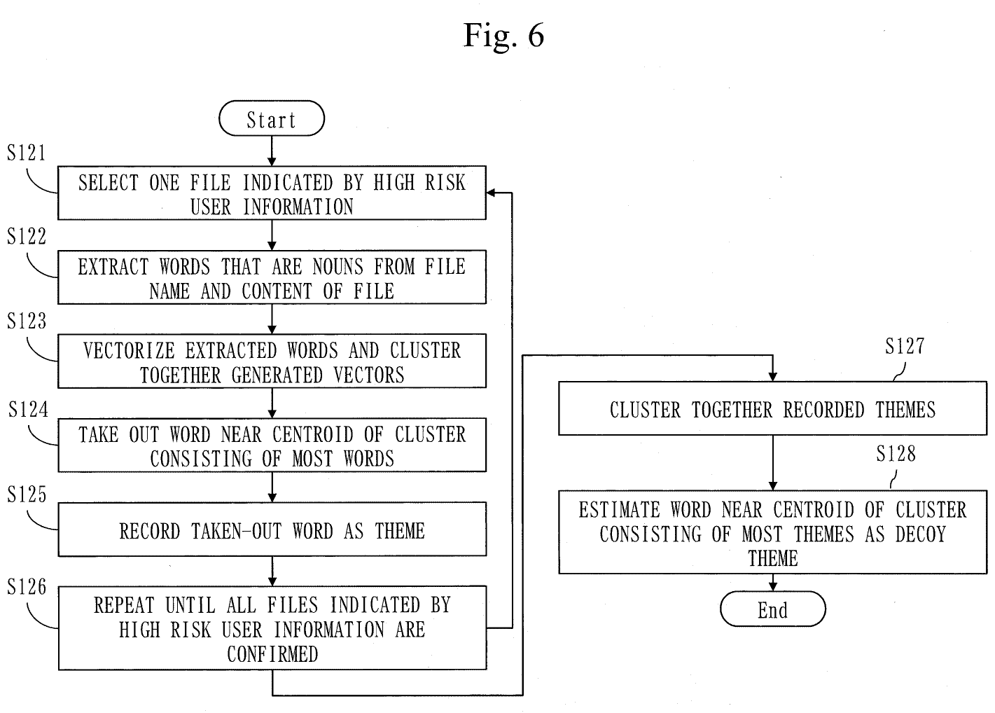

FIG. 6 is a flowchart showing an example of the process of the decoy theme estimation unit 130 in a case of estimating the decoy theme using the natural language processing technology in step S102. FIG. 6 is used to describe the process of the decoy theme estimation unit 130. In this example, it is assumed that a word embedding model is prepared in advance. The word embedding model may be a publicly available model, a model created using files existing within the target system 20, or a model in which information from files within the target system 20 is added to a publicly available word embedding model.

### (Step S121)

The decoy theme estimation unit 130 selects one file indicated by the high risk user information 121 and accessed by the target user.

### (Step S122)

The decoy theme estimation unit 130 extracts words that are nouns from the file name and content of the file selected in step S121.

### (Step S123)

The decoy theme estimation unit 130, using a word embedding model, vectorizes each word extracted in step S122 and clusters together the generated vectors.

### (Step S124)

The decoy theme estimation unit 130 takes out a word existing near the centroid of a cluster consisting of the most words.

### (Step S125)

The decoy theme estimation unit 130 records the word taken out in step S124 as the theme.

### (Step S126)

The decoy theme estimation unit 130 repeats the process of step S121 through step S125 until all files accessed by the target user, among the files indicated by the high risk user information 121, are confirmed.

### (Step S127)

The decoy theme estimation unit 130 clusters together all the themes recorded in step S125 after confirming all the files accessed by the target user.

### (Step S128)

The decoy theme estimation unit 130 estimates as the decoy theme the word existing near the centroid of a cluster consisting of the most themes.

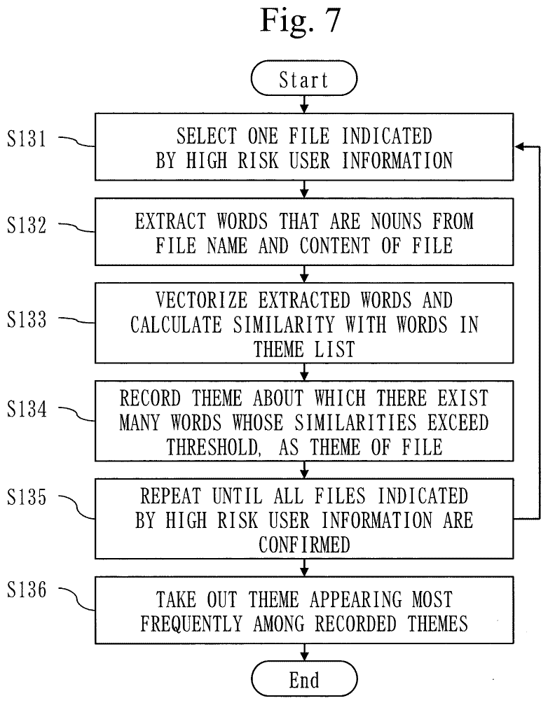

FIG. 7 is a flowchart showing an example of the process of the decoy theme estimation unit 130 when estimating the decoy theme by using both the rule base and the natural language processing in step S102. FIG. 7 is used to describe the process of the decoy theme estimation unit 130. In this example, it is assumed that a word embedding model is prepared in advance and a theme list is created in advance.

### (Step S131)

The decoy theme estimation unit 130 selects one file indicated by the high risk user information 121 and accessed by the target user.

### (Step S132)

The decoy theme estimation unit 130 extracts words that are nouns from the file name and content of the file selected in step S131.

### (Step S133)

The decoy theme estimation unit 130 vectorizes each word extracted in step S132, using the word embedding model. After that, the decoy theme estimation unit 130 calculates the similarity between each generated vector and the vector corresponding to each word included in the theme list.

### (Step S134)

The decoy theme estimation unit 130 records, among the themes included in the theme list, the theme about which there exist relatively many words whose corresponding similarities are equal to or greater than a threshold value, as the theme of the file selected in step S131, based on the similarity calculated in step S133.

### (Step S135)

The decoy theme estimation unit 130 repeats the process of step S131 through step S134 until all files accessed by the target user, among the files indicated by the high risk user information 121, are confirmed.

### (Step S136)

The decoy theme estimation unit 130 estimates, as the decoy theme, the theme appearing most frequently among all the themes recorded in step S134, after processing all the files accessed by the target user.

### (Step S103: Decoy File Placement Process)

The decoy placement unit 140 selects a decoy file 191 that matches the decoy theme estimated by the decoy theme estimation unit 130 from the decoy file DB 190, and places the selected decoy file 191 in the target system 20.

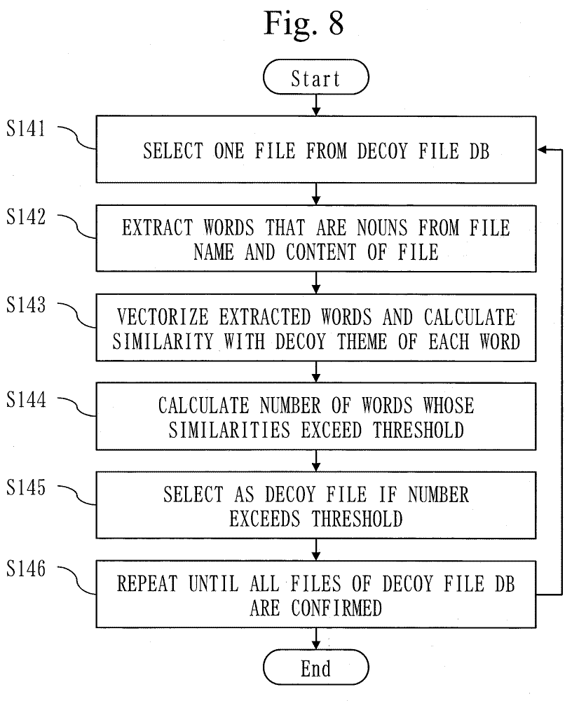

FIG. 8 is a flowchart showing an example of the process of the decoy placement unit 140 in a case of selecting the decoy file 191 using the natural language processing technology in step S103. FIG. 8 is used to describe the process of the decoy placement unit 140. It is assumed that a word embedding model is prepared in advance in this example.

### (Step S141)

The decoy placement unit 140 selects the decoy file 191 from the decoy file DB 190.

### (Step S142)

The decoy placement unit 140 extracts words that are nouns from the file name and content of the decoy file 191 selected in step S141.

### (Step S143)

The decoy placement unit 140 vectorizes each word extracted in step S142 using the word embedding model. After that, the decoy placement unit 140 calculates the similarity between each generated vector and the vector corresponding to the word estimated as the decoy theme.

### (Step S144)

The decoy placement unit 140 calculates the number of words whose corresponding similarities calculated in step S143 exceed a predetermined threshold, among the words extracted in step S142.

### (Step S145)

The decoy placement unit 140 selects the decoy file 191 selected in step S141 as the decoy file 191 to be placed if the number of words whose corresponding similarities exceeding the predetermined threshold surpasses the predetermined threshold. The selected decoy file 191 is a decoy file 191 that matches the decoy theme.

### (Step S146)

The decoy placement unit 140 repeats the process of step S141 through step S145 until all the decoy files 191, among the decoy files 191 stored in the decoy file DB 190, that match the decoy theme are confirmed.

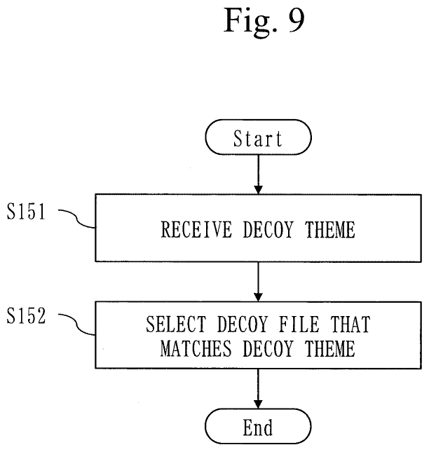

FIG. 9 is a flowchart showing an example of the process of the decoy placement unit 140 in case of selecting the decoy file 191 using both the rule base and the natural language processing in step S103. FIG. 9 is used to describe the process of the decoy placement unit 140. In this example, it is assumed that a theme list has been created in advance.

### (Step S151)

The decoy placement unit 140 receives information indicating the decoy theme from the decoy theme estimation unit 130.

### (Step S152)

The decoy placement unit 140 selects from the decoy file DB 190 the decoy file 191 that matches the decoy theme indicated by the received information. It is assumed that a decoy file 191 is created for each theme indicated by the theme list.

### (Step S104: Decoy Monitoring Process)

The decoy monitoring unit 150 monitors access to the decoy file 191, generates the decoy file access information 151 indicating the monitoring results, and outputs the generated decoy file access information 151.

### (Step S105: High Risk User Information Correction Process)

The risk value calculation unit 120 corrects the high risk user information 121 based on the outputted decoy file access information 151.

### Explanation of Effects of Embodiment 1

In conventional technology, even if there are internal fraudsters attempting to leak information contained in files and so on created in daily operations, a problem exists that it is not possible to automatically select and place a decoy file related to the information sought by the internal fraudsters.

On the other hand, according to this Embodiment, based on the high risk user information 121, the themes of files and folders viewed by the high risk user are analyzed, the theme of interest to the high risk user is estimated, and the decoy file 191 that matches the estimated theme is placed in the target system 20. Therefore, according to this Embodiment, it is possible to analyze the themes of files and folders viewed by the internal fraudster, estimate the theme of interest to the internal fraudster, automatically select the decoy file 191 related to the information sought by the internal fraudster based on the estimated theme, and place the selected decoy file.

### Other Configurations

### <Modification 1>

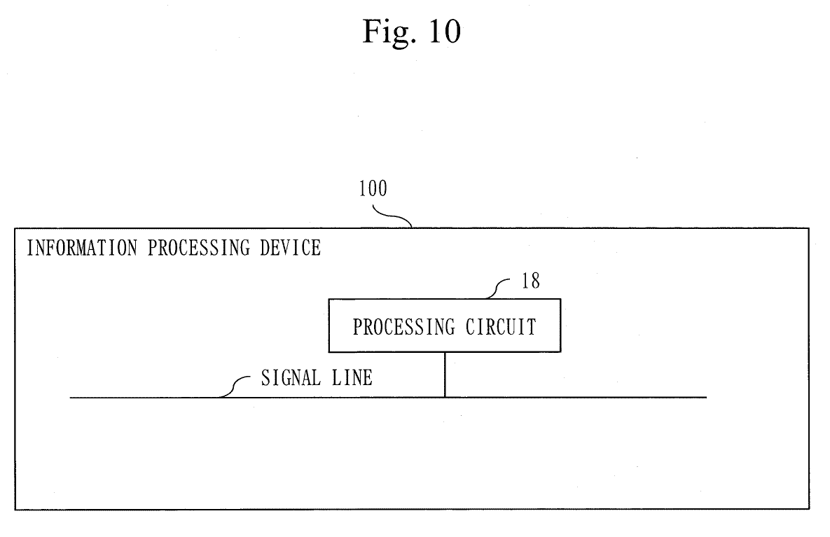

FIG. 10 shows a hardware configuration example of an information processing device 100 according to this modification.

The information processing device 100 includes a processing circuit 18, instead of a processor 11, or a processor 11 and a storage device 12.

The processing circuit 18 is hardware that implements at least part of each unit provided in the information processing device 100.

The processing circuit 18 may be dedicated hardware or a processor that executes a program stored in the storage device 12.

When the processing circuit 18 is dedicated hardware, the processing circuit 18, as a specific example, is a single circuit, a composite circuit, a programmed processor, a parallel-programmed processor, an ASIC (Application Specific Integrated Circuit), an FPGA (Field Programmable Gate Array), or a combination of these.

The information processing device 100 may include multiple processing circuits that substitute for the processing circuit 18. The multiple processing circuits share the role of the processing circuit 18.

In the information processing device 100, some of the functions may be implemented by dedicated hardware, and the remaining functions may be implemented by software or firmware.

The processing circuit 18 is implemented, as a specific example, by hardware, software, firmware, or a combination of these.

The processor 11, the storage device 12, and the processing circuit 18 are collectively referred to as “processing circuitry”. In other words, the function of each functional component of the information processing device 100 is implemented by processing circuitry.

An information processing device 100 according to another embodiment may have the same configuration as this modification.

### Embodiment 2

Below, the points differing from the aforementioned Embodiment will mainly be described with reference to the drawings.

### ***Description of Configuration***

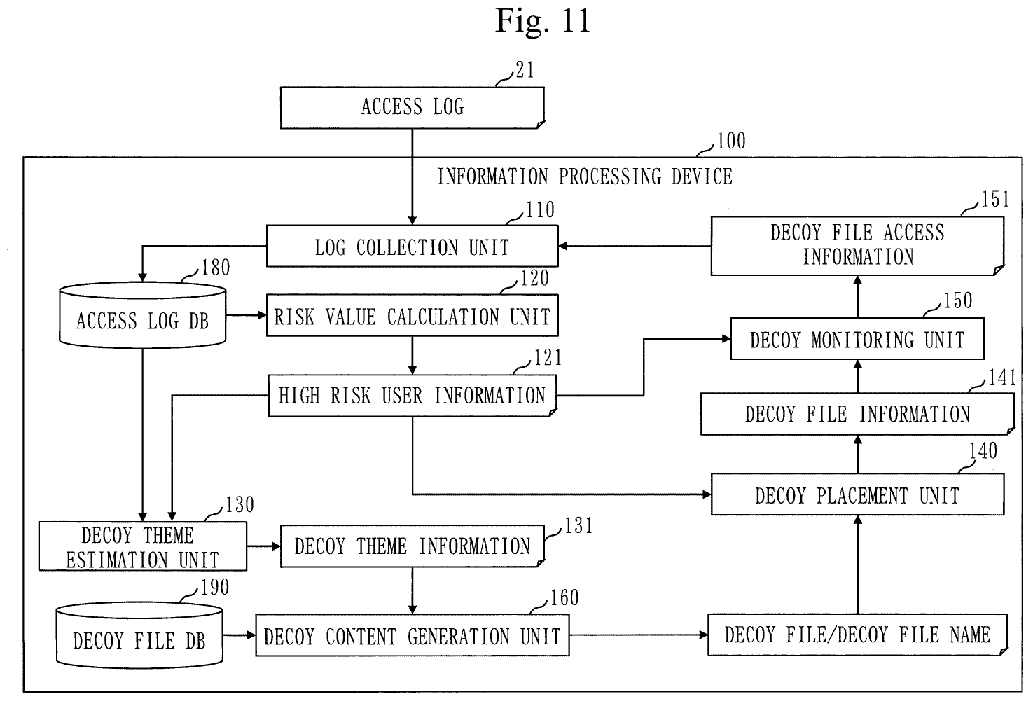

FIG. 11 shows a configuration example of an information processing device 100 according to this Embodiment.

As shown in FIG. 11, the information processing device 100 further includes a decoy content generation unit 160 compared to the information processing device 100 according to Embodiment 1.

The decoy content generation unit 160 selects a file from a decoy file DB 190 as a decoy file 191 that matches a decoy theme, based on the decoy theme estimated by the decoy theme estimation unit 130. The decoy content generation unit 160 generates a file name for the selected decoy file 191 as the decoy file name by using natural language processing techniques based on the decoy theme estimated by the decoy theme estimation unit 130, and outputs the selected decoy file 191 along with information indicating the generated decoy file name. The decoy file name is a file name designed to increase the likelihood that an internal fraudster will check the decoy file 191 corresponding to the decoy file name.

The method of generating a decoy file name based on a decoy theme includes, as a specific example, using a rule base or natural language processing techniques. Specifically, a method may be available that adds characters to the file name of each file accessed by a high risk user corresponding to the decoy theme using a rule base. The characters added to the file name include, as specific examples, “_update” or “_(date)”. Additionally, a method may also be available that generates a decoy file name by taking out words that are nouns from multiple file names corresponding to the decoy theme using natural language processing, extracting common words from the taken-out words, and modifying the nouns included in the file name of the existing decoy file 191 to include the extracted words.

A decoy placement unit 140 according to this Embodiment uses the decoy file 191 and the file name which are outputted by the decoy content generation unit 160. In other words, the decoy placement unit 140 uses the file selected by the decoy content generation unit 160 as the decoy file 191 and uses the file name generated by the decoy content generation unit 160 as the file name of the decoy file 191.

### ***Description of Operation***

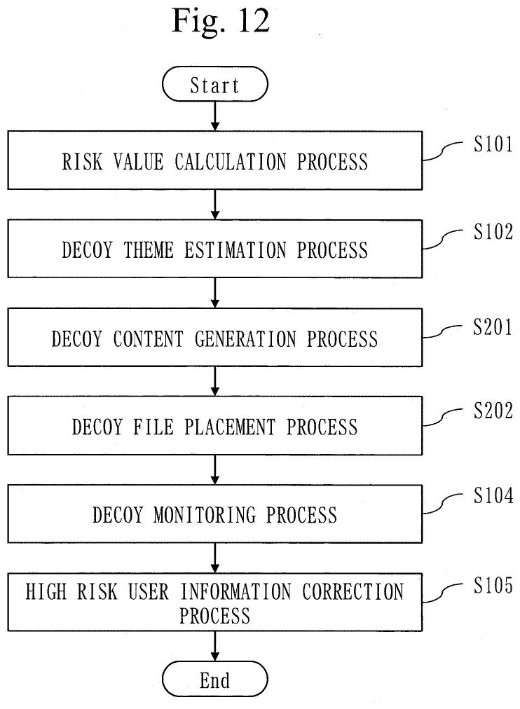

FIG. 12 is a flowchart showing an example of the operation of the information processing device 100. FIG. 12 is used to describe the operation of the information processing device 100.

### (Step S201: Decoy Content Generation Process)

The decoy content generation unit 160 selects the decoy file 191 that matches the decoy theme estimated by the decoy theme estimation unit 130 from the decoy file DB 190, generates a decoy file name based on the decoy theme, and uses the generated decoy file name as the file name of the selected decoy file 191.

### (Step S202: Decoy File Placement Process)

The decoy placement unit 140 places the decoy file 191 selected by the decoy content generation unit 160 in the target system 20. At this time, the decoy placement unit 140 uses the decoy file name generated by the decoy content generation unit 160 as the file name of this decoy file 191.

### Explanation of Effects of Embodiment 2

According to this Embodiment, the decoy content generation unit 160 generates the file name of the decoy file 191 based on the decoy theme. Therefore, according to this Embodiment, it is possible to automatically generate a decoy file 191, which has a relatively high possibility of being checked by an internal fraudster, and place it in the target system 20.

### Embodiment 3

Below, the points different from the aforementioned Embodiment will mainly be described with reference to the drawings.

### ***Description of Configuration***

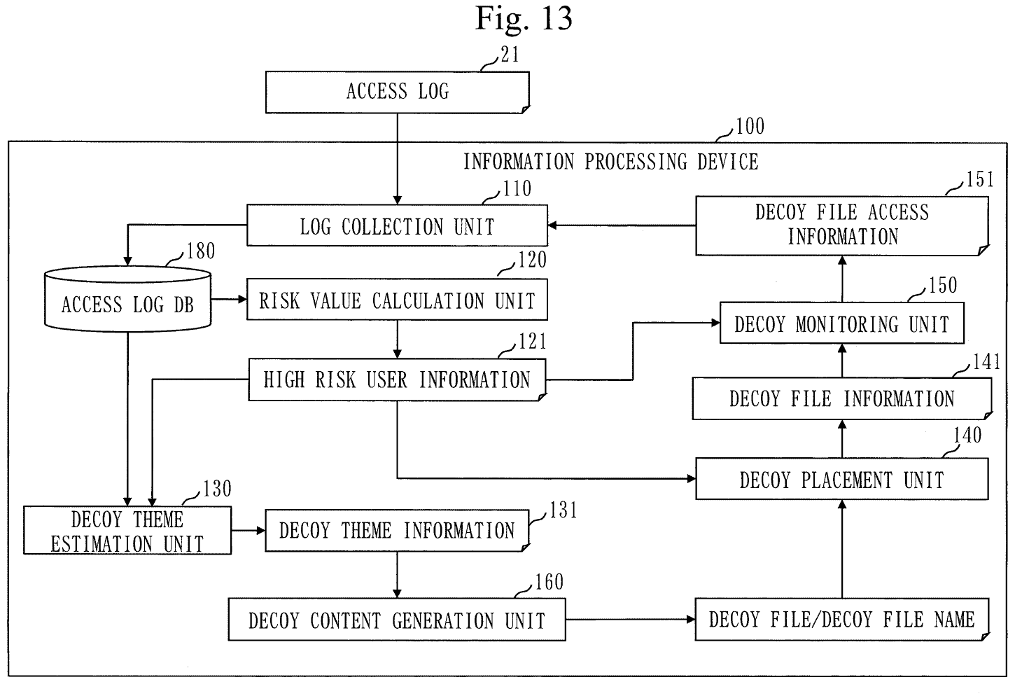

FIG. 13 shows an example of the configuration of an information processing device 100 according to this Embodiment. As shown in FIG. 13, the information processing device 100, compared to the information processing device 100 according to Embodiment 1, includes a decoy content generation unit 160 and does not store a decoy file DB 190.

The decoy content generation unit 160 generates a decoy file 191 using natural language processing technology and other methods based on the decoy theme. Specifically, the decoy content generation unit 160 generates the content and file name of the decoy file 191. The content and file name of the decoy file 191 are designed to increase the likelihood that an internal fraudster will check the decoy file 191.

A decoy placement unit 140 according to this Embodiment uses a file generated by the decoy content generation unit 160 as the decoy file 191.

### ***Description of Operation***

Each element of the flowchart showing the operation of the information processing device 100 according to this Embodiment is the same as a corresponding element of the flowchart showing the operation of the information processing device 100 according to Embodiment 2. Below, the differences from Embodiment 2 will be described.

### (Step S201: Decoy Content Generation Process)

The decoy content generation unit 160 generates the content and file name of the decoy file 191 based on the decoy theme estimated by a decoy theme estimation unit 130.

### (Step S202: Decoy File Placement Process)

The decoy placement unit 140 places the decoy file 191 generated by the decoy content generation unit 160 in a target system 20.

### Explanation of Effects of Embodiment 3

According to this Embodiment, the decoy content generation unit 160 generates the decoy file 191 based on the decoy theme. Therefore, according to this Embodiment, it is possible to automatically generate the decoy file 191, which has a relatively high possibility of being checked by an internal fraudster, and place it in the target system 20.

### ***Other Configurations***

### <Modification 2>

A viewing time of each file by a target user is considered to vary depending on the strength of the target user's interest. Specifically, it is considered that the target user views files related to themes in which they are more interested, for a longer time. Therefore, in this modification, the viewing time of each file by the target user is taken into consideration.

A configuration of an information processing device 100 according to this modification is the same as the configuration of the information processing device 100 according to Embodiment 3.

The decoy theme estimation unit 130 according to this modification estimates the decoy theme corresponding to the target user based on each file indicated by high risk user information 121 and accessed by the target user, and a viewing time by the target user of each file stored in the target system 20. A decoy theme estimation unit 130 may estimate the decoy theme corresponding to the target user based on a difference between a standard viewing time of each file and a viewing time of that file by the target user. Additionally, the decoy theme estimation unit 130 may estimate the decoy theme corresponding to the target user based on the time the target user stayed for each folder, or may estimate the decoy theme corresponding to the target user by considering the number of times or frequency of accesses to each folder or each file by the target user. The decoy theme estimation unit 130 need not necessarily use each file where the viewing time by the target user is not greater than a threshold when estimating the decoy theme corresponding to the target user.

In estimating the decoy theme corresponding to the target user using the theme list, assuming that each file is a target theme, the decoy theme estimation unit 130, as described with using FIG. 7, may count a value corresponding to the viewing time by the target user for each file corresponding to the target theme as an occurrence frequency of the target theme, instead of simply counting the occurrence frequency of each theme. In this case, the decoy theme estimation unit 130, as a specific example, sets the occurrence frequency of the theme corresponding to the target file to 0.5 when the viewing time of the target file by the target user is not greater than the threshold, and to 1.5 when the viewing time of the target file by the target user is greater than the threshold. Here, the target file is the file accessed by the target user. Additionally, the decoy theme estimation unit 130 may set a coefficient that increases as the viewing time of the file becomes longer, and count the occurrence frequency of the theme corresponding to each file.

A decoy content generation unit 160 according to this modification generates the content and file name of a decoy file 191 based on the decoy theme and the viewing time of each file.

The decoy content generation unit 160, when generating the content of the decoy file 191 that matches the decoy theme corresponding to the target user using natural language processing technology, as a specific example, uses a file having a viewing time by the target user that is equal to or above the threshold, among files that match the decoy theme, as input in natural language processing.

The decoy content generation unit 160, when generating the file name of the decoy file 191 that matches the decoy theme corresponding to the target user, as a specific example, uses the file name of the file having a viewing time by the target user that is equal to or above the threshold, among files that match the decoy theme, as the base for the file name. Additionally, the decoy content generation unit 160 may select the top X pieces of files in order of length of viewing time by the target user, among the files that match the decoy theme, and use the file name of each selected file as the base for the file name.

According to this modification, the decoy file 191 is a file generated based on the viewing time of the high risk user. Therefore, according to this modification, it is possible to place the decoy file 191, which has a relatively high possibility of being accessed by the high risk user, in the target system 20.

It should be noted that the decoy theme estimation method according to this modification may be appropriately combined with the decoy file 191 selection method or generation method according to an Embodiment.

### Embodiment 4

The following describes mainly the differences from the aforementioned Embodiments with reference to the drawings.

### ***Description of Configuration***

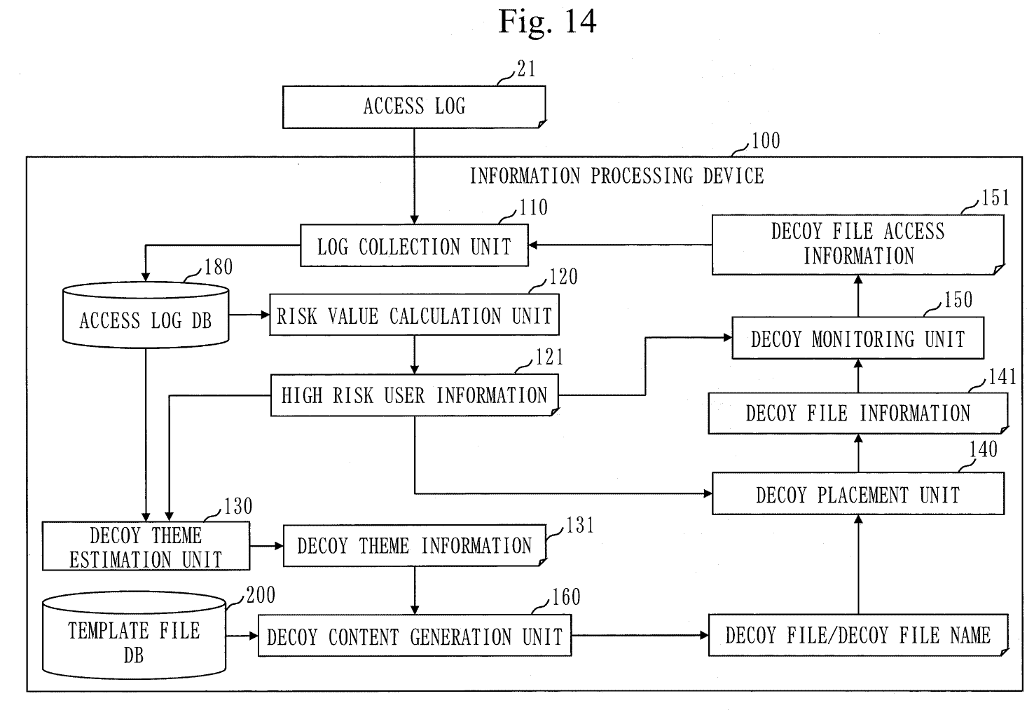

FIG. 14 shows an example configuration of an information processing device 100 according to this Embodiment. As shown in FIG. 14, the information processing device 100, compared to the information processing device 100 according to Embodiment 1, includes a decoy content generation unit 160 and stores a template file DB 200 instead of a decoy file DB 190.

The decoy content generation unit 160 selects a template file from the template file DB 200 based on a decoy theme estimated by a decoy theme estimation unit 130, modifies the selected template file based on the decoy theme estimated by the decoy theme estimation unit 130, and outputs the modified template file as a decoy file 191. In this process, the decoy content generation unit 160, as a specific example, modifies the content and file name of the template file to content and file name suitable for the decoy theme. The decoy content generation unit 160 may select a template file according to the decoy theme.

A decoy placement unit 140 according to this Embodiment uses the template file modified by the decoy content generation unit 160 as the decoy file 191.

The template file DB 200 is a database that stores candidate template files corresponding to the decoy file 191. The template file corresponding to the decoy file 191 is a file used as a template for the decoy file 191. The template file DB 200 may store a template file corresponding to each decoy theme that the decoy theme estimation unit 130 may output.

### ***Description of Operation***

Each element of flowchart showing the operation of the information processing device 100 according to this Embodiment is the same as a corresponding element of the flowchart showing the operation of the information processing device 100 according to Embodiment 2.

### (Step S201: Decoy Content Generation Process)

The decoy content generation unit 160 selects a template file from the template file DB 200, modifies the content and file name of the selected template file to content and file name suitable for the decoy theme estimated by the decoy theme estimation unit 130, and outputs the template file with the modified content and file name as the decoy file 191.

### (Step S202: Decoy File Placement Process)

The decoy placement unit 140 places the decoy file 191 generated by the decoy content generation unit 160 in a target system 20.

### Explanation of the Effects of Embodiment 4

According to this Embodiment, the decoy content generation unit 160 generates the decoy file 191 based on the decoy theme and template file. Therefore, according to this Embodiment, it is possible to automatically generate the decoy file 191, which has a relatively high possibility of being checked by an internal fraudster, and place it in the target system 20.

### Other Embodiments

It is possible to combine the aforementioned Embodiments arbitrarily, modify any component of each Embodiment, or omit any component in each Embodiment.

Moreover, the embodiments are not limited to those shown in Embodiments 1 to 4, and various changes can be made as needed. The procedures described using flowcharts, etc., may be appropriately modified.

### REFERENCE SIGNS LIST

11: processor; 12: storage device; 18: processing circuit; 20: target system; 21: access log; 90: information processing system; 100: information processing device; 110: log collection unit; 120: risk value calculation unit; 121: high risk user information; 130: decoy theme estimation unit; 131: decoy theme information; 140: decoy placement unit; 141: decoy file information; 150: decoy monitoring unit; 151: decoy file access information; 160: decoy content generation unit; 180: access log DB; 190: decoy file DB; 191: decoy file; 200: template file DB.

1. An information processing device comprising:
processing circuitry
to estimate a decoy theme which is a theme of information that a high risk user being a user of a target system is attempting to leak externally, based on an access log indicating access in the target system by the high risk user, and
to place a decoy file matching the estimated decoy theme in the target system.

2. The information processing device according to claim 1,
wherein the processing circuitry calculates a risk value corresponding to each user based on an access pattern in the target system of each user of the target system, and
wherein the high risk user is, among users of the target system, a user whose corresponding risk value is equal to or greater than a risk criterion value.

3. The information processing device according to claim 2, wherein the processing circuitry increases a risk value corresponding to the target user if the target user, who is a user of the target system, accesses the decoy file.

4. The information processing device according to claim 1, wherein the processing circuitry selects a file from a database storing files that are candidates for the decoy file based on the estimated decoy theme.

5. The information processing device according to claim 4, wherein the processing circuitry
estimates the decoy theme using at least one or the other of natural language processing and a theme list consisting of multiple themes each of which is a candidate for the decoy theme, and
selects the decoy file from the database using at least one or the other of natural language processing and the theme list.

6. The information processing device according to claim 1, wherein the processing circuitry
selects a file from a database storing files that are candidates for the decoy file based on the estimated decoy theme, and generates a file name for the decoy file based on the estimated decoy theme, and
uses the selected file as the decoy file and uses the generated file name as the file name of the decoy file.

7. The information processing device according to claim 1, wherein the processing circuitry
generates a file based on the estimated decoy theme as the decoy file, and
uses the generated file as the decoy file.

8. The information processing device according to claim 1, wherein the processing circuitry
selects a template file from a database storing candidates for a template file corresponding to the decoy file based on the estimated decoy theme and modifies the selected template file based on the estimated decoy theme, and
uses the modified template file as the decoy file.

9. The information processing device according to claim 1, wherein the processing circuitry estimates the decoy theme based on a viewing time by the high risk user of each file stored in the target system.

10. An information processing method comprising:
by a computer, estimating a decoy theme which is a theme of information that a high risk user being a user of a target system is attempting to leak externally, based on an access log indicating access in the target system by the high risk user; and
by the computer, placing a decoy file matching the estimated decoy theme in the target system.

11. A non-transitory computer readable medium recorded with an information processing program which causes an information processing device, being a computer, to execute:
a decoy theme estimation process of estimating a decoy theme which is a theme of information that a high risk user being a user of a target system is attempting to leak externally, based on an access log indicating access in the target system by the high risk user; and
a decoy placement process of placing a decoy file matching the estimated decoy theme in the target system.
